(19) United States
(12) Patent Application Publication
(10) Pub. No.: US 2026/0229039 A1
(43) Pub. Date: Aug. 6, 2026

(54) ABNORMALITY DETECTION DEVICE, ABNORMALITY DETECTION METHOD, AND PROGRAM

(71) Applicant: NEC Corporation, Tokyo (JP)

(72) Inventors: Tetsuo INOSHITA, Tokyo (JP); Yuichi NAKATANI, Tokyo (JP)

(73) Assignee: NEC Corporation, Tokyo (JP)

(21) Appl. No.: 19/149,924

(22) PCT Filed: Dec. 26, 2023
(86) PCT No.: PCT/JP2023/046725

§ 371 Date: Jul. 22, 2025

(30) Foreign Application Priority Data
Jan. 25, 2023 (JP) 2023-009536

(51) Int. Cl. G06V 20/54; G06T 11/00; G06V 10/26; G06V 10/774; G06V 10/776

(52) U.S. Cl. CPC G06V 20/54; G06T 11/00; G06V 10/273; G06V 10/7747; G06V 10/776

(57) ABSTRACT

An abnormality detection device according to the present invention generates a plurality of altered images by altering each of a plurality of captured images that are in a time sequence. Alteration of the captured images includes masking processing of masking one or more partial regions included in the captured images, and restoration processing of restoring the masked partial regions using data from other than the partial regions. For each of the plurality of captured images, the abnormality detection device calculates difference data representing difference between the captured image and the altered image generated from the captured image, and determines whether or not the captured images represent an abnormal state on the basis of a plurality of pieces of the calculated difference data.

### TECHNICAL FIELD

The present disclosure relates to an abnormality detection device, an abnormality detection method, and a program.

### BACKGROUND ART

A technique for detecting an abnormality by image analysis has been developed. For example, PTL 1 discloses a technique for detecting a defective product by image analysis. A system of PTL 1 masks a part of an image of an item such as a product, and then, restores the image and compares the original image with the image obtained by restoration so as to detect a defect of the item.

### CITATION LIST

### Patent Literature

PTL 1: JP 2020-525940 A

### Non Patent Literature

NPL 1: Zhenda Xie, Zheng Zhang, Yue Cao, Yutong Lin, Jianmin Bao, Zhuliang Yao, Qi Dai, and Han Hu, “SimMIM: A Simple Framework for Masked Image Modeling”, [online], Nov. 18, 2021, [searched on Jan. 16, 2023], Internet, <URL:https://arxiv.org/pdf/2111.09886.pdf>

### SUMMARY OF INVENTION

### Technical Problem

PTL 1 does not assume that a situation of an abnormality detection target changes. The present disclosure has been made in view of the above problem, and one of objects of the present disclosure is to provide a new technology for detecting an abnormality by using an image.

### Solution to Problem

An abnormality detection device according to the present disclosure includes generation means for generating a plurality of processed images, by processing each of a plurality of time-series captured images, calculation means for calculating difference data representing a difference between the captured image and the processed image generated from the captured image, for each of the plurality of captured images, and determination means for determining whether the captured image represents an abnormal state, based on a plurality of pieces of the calculated difference data. The processing executed on the captured image includes mask processing for masking one or more partial regions included in the captured image and restoration processing for restoring the masked partial region by using data other than the partial region.

An abnormality detection method according to the present disclosure is executed by a computer. The abnormality detection method includes a generation step for generating a plurality of processed images, by processing each of a plurality of time-series captured images, a calculation step for calculating difference data representing a difference between the captured image and the processed image generated from the captured image, for each of the plurality of captured images, and a determination step for determining whether the captured image represents an abnormal state, based on a plurality of pieces of the calculated difference data. The processing executed on the captured image includes mask processing for masking one or more partial regions included in the captured image and restoration processing for restoring the masked partial region by using data other than the partial region.

A program according to the present disclosure causes a computer to execute the abnormality detection method according to the present disclosure.

### Advantageous Effects of Invention

According to the present disclosure, a new technology for detecting an abnormality using an image is provided.

### BRIEF DESCRIPTION OF DRAWINGS

FIG. 1 is a diagram illustrating an overview of an abnormality detection device.

FIG. 2 is a diagram illustrating an overview of processing executed on a captured image.

FIG. 3 is a block diagram illustrating a functional configuration of the abnormality detection device.

FIG. 4 is a block diagram illustrating a hardware configuration of a computer that implements the abnormality detection device.

FIG. 5 is a flowchart illustrating a flow of processing executed by the abnormality detection device.

FIG. 6 is a diagram illustrating mask processing using a mask image.

FIG. 7 is a diagram illustrating a case where two mask images are alternately applied.

FIG. 8 is a diagram illustrating a case where a normal region is excluded from a mask target region.

FIG. 9 is a diagram illustrating a functional configuration of the abnormality detection device that includes an output unit.

FIG. 10 is a diagram illustrating an observation screen including a display indicating that an observation range is in an abnormal state.

### EXAMPLE EMBODIMENT

Hereinafter, example embodiments of the present disclosure will be described in detail with reference to the drawings. In the drawings, the same or related elements are denoted by the same reference numerals, and repeated description is omitted as necessary for clarity of description. In addition, unless otherwise described, predetermined values such as predetermined values or threshold values are stored in advance in a storage device or the like accessible from a device using the values. Furthermore, unless otherwise described, a storage unit includes one or more storage devices of any number.

### <Overview>

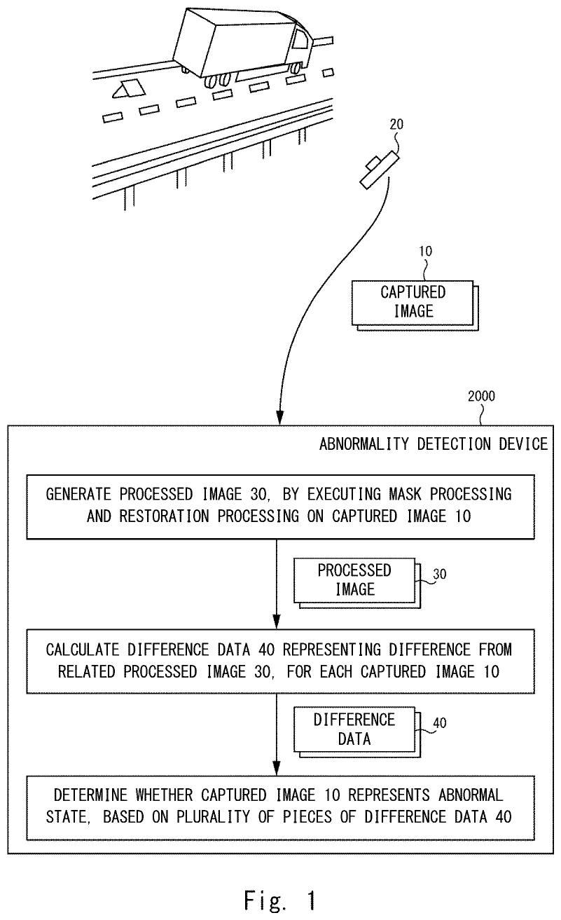

FIG. 1 is a diagram illustrating an overview of an abnormality detection device 2000 according to an example embodiment. Here, FIG. 1 is a diagram for facilitating understanding of the overview of the abnormality detection device 2000, and an operation of the abnormality detection device 2000 is not limited to that illustrated in FIG. 1.

The abnormality detection device 2000 acquires a plurality of captured images 10 and determines whether the captured image 10 indicates an abnormal state. The plurality of captured images 10 acquired by the abnormality detection device 2000 is time-series image data generated by a camera 20. For example, the camera 20 is configured to generate video data by repeatedly performing imaging. In this case, each captured image 10 is a video frame constituting the video data.

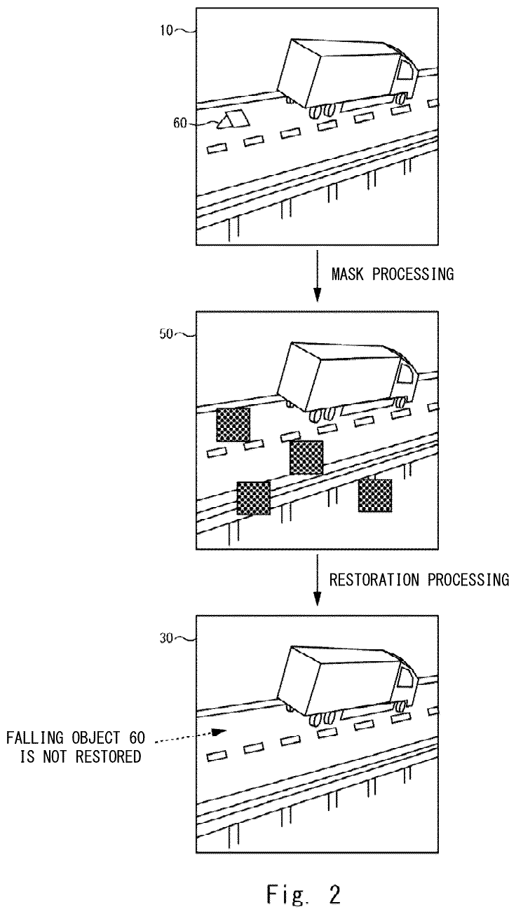

The abnormality detection device 2000 generates a processed image 30 from the captured image 10, by executing processing on each captured image 10. FIG. 2 is a diagram illustrating an overview of the processing executed on the captured image 10. The processing executed on the captured image 10 includes mask processing and restoration processing. The mask processing is processing for generating an intermediate image 50, by masking at least one partial region included in the captured image 10. In FIG. 2, the masked image region is represented by a dot pattern. The restoration processing is processing for generating the processed image 30, by restoring the masked partial region, with respect to the intermediate image 50 (that is, a captured image 10 having a masked partial region).

Here, the processing for restoring the masked partial region in the certain intermediate image 50 is processing for estimating content of the partial region, by using data of an image region other than the partial region, included in the intermediate image 50. Therefore, some difference may occur between the processed image 30 and the captured image 10 that is a source of the processed image 30.

For example, in FIG. 2, the captured image 10 is an image obtained by imaging a road. In the captured image 10, a falling object 60 is imaged. In the intermediate image 50, an image region representing the falling object 60 is masked. Here, in the restoration processing based on an unmasked image region, the falling object 60 is not restored. Therefore, the processed image 30 obtained by the restoration processing does not include the falling object 60. Therefore, a difference is generated between the captured image 10 and the intermediate image 50.

The abnormality detection device 2000 calculates difference data 40 representing a difference between each captured image 10 and the processed image 30 generated from the captured image 10. Then, the abnormality detection device 2000 executes processing (hereinafter, abnormality determination processing) for determining whether the captured image 10 represents an abnormal state, using the plurality of pieces of calculated difference data 40.

Here, the abnormal state represented by the captured image 10 is, for example, “a state where an object that does not normally exist, exists in an imaging range of the camera 20”. The object that does not normally exist is, for example, a foreign object such as a falling object, a left object (hereinafter, a left object), or the like. Hereinafter, the imaging range of the camera 20 is also referred to as an “observation range”.

For example, it is assumed that the camera 20 be a camera used to monitor a situation of a road. In this case, for example, a foreign object on the road is an object that does not normally exist, on the road that is the observation range. Therefore, in a case where such a foreign object is imaged in the captured image 10, the captured image 10 represents the abnormal state.

In addition, for example, it is assumed that the camera 20 be a camera used for monitoring in a facility such as an airport. In this case, for example, the left object is an object that does not normally exist in the observation range. Therefore, in a case where such a left object is imaged in the captured image 10, the captured image 10 represents the abnormal state.

### Example of Operation and Effect

According to the abnormality detection device 2000, by executing the processing including the mask processing and the restoration processing on each of the plurality of time-series captured images 10, the processed image 30 is obtained. Moreover, for each of the plurality of captured images 10, the difference data 40 representing the difference from the processed image 30 generated from the captured image 10 is generated. Then, by using the plurality of pieces of difference data 40, it is determined whether the captured image 10 represents the abnormal state.

Here, a method is also considered of determining whether the captured image 10 represents the abnormal state, based on only a difference between a single captured image 10 and a processed image 30 generated from the captured image 10. However, in this method, even if the difference between the captured image 10 and the processed image 30 occurs due to an influence of temporary noise, there is a possibility that it is determined that the captured image 10 represents the abnormal state. In this regard, according to the abnormality detection device 2000, since the plurality of pieces of difference data 40 is obtained by using the plurality of captured images 10 and an abnormality is detected by using the plurality of pieces of difference data 40, it is possible to prevent erroneous detection of an abnormality caused by the influence of the temporary noise.

Hereinafter, the abnormality detection device 2000 of the present example embodiment will be described in more detail.

### Example of Functional Configuration

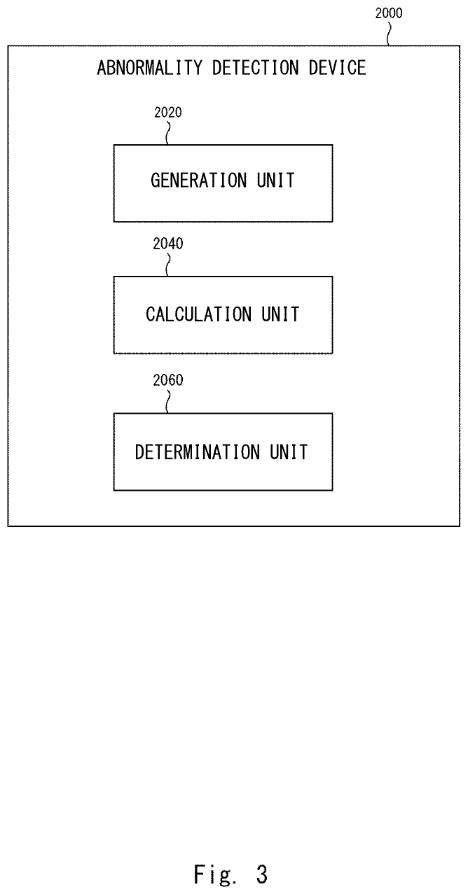

FIG. 3 is a block diagram illustrating a functional configuration of the abnormality detection device 2000 according to the present example embodiment. The abnormality detection device 2000 includes a generation unit 2020, a calculation unit 2040, and a determination unit 2060. The generation unit 2020 generates the plurality of processed images 30, by executing the processing on each of the plurality of captured images 10. The calculation unit 2040 calculates the difference data 40 representing the difference from the processed image 30 generated from the captured image 10, for each of the plurality of captured images 10. The determination unit 2060 determines whether a scene represented by the captured image 10 represents a predetermined situation, based on the plurality of pieces of calculated difference data 40.

### Example of Hardware Configuration

Each functional component of the abnormality detection device 2000 may be implemented by hardware that implements each functional component (for example, a hard-wired electronic circuit) or may be implemented by a combination of hardware and software (for example, a combination of an electronic circuit and a program that controls the electronic circuit or the like). Hereinafter, a case where each functional component of the abnormality detection device 2000 is implemented by a combination of hardware and software will be further described.

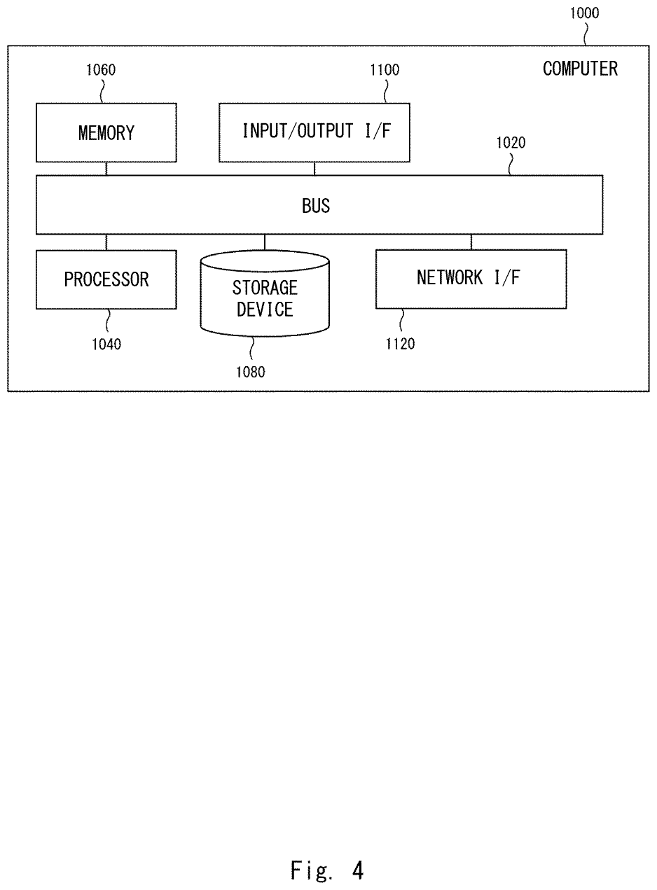

FIG. 4 is a block diagram illustrating a hardware configuration of a computer 1000 that implements the abnormality detection device 2000. The computer 1000 is any computer. For example, the computer 1000 is a stationary computer such as a personal computer (PC) or a server machine. In another example, the computer 1000 is a portable computer such as a smartphone or a tablet terminal. The computer 1000 may be a dedicated computer designed to implement the abnormality detection device 2000 or may be a general-purpose computer.

For example, by installing a predetermined application with respect to the computer 1000, each function of the abnormality detection device 2000 is implemented by the computer 1000. The above-described application is configured with a program for implementing the functional components of the abnormality detection device 2000. Note that any method of acquiring the program can be used. For example, the program can be acquired from a storage medium (a DVD disk, a USB memory, or the like) in which the program is stored. The program can also be acquired, for example, by downloading the program from a server device that manages the storage device in which the program is stored.

The computer 1000 includes a bus 1020, a processor 1040, a memory 1060, a storage device 1080, an input/output interface 1100, and a network interface 1120. The bus 1020 is a data transmission path for the processor 1040, the memory 1060, the storage device 1080, the input/output interface 1100, and the network interface 1120 to transmit and receive data to and from each other. However, the method of connecting the processor 1040 and the like to each other is not limited to the bus connection.

The processor 1040 is any of processors such as a central processing unit (CPU), a graphics processing unit (GPU), or a field-programmable gate array (FPGA). The memory 1060 is a primary storage device implemented by using a random access memory (RAM) or the like. The storage device 1080 is a secondary storage device implemented by using a hard disk, a solid state drive (SSD), a memory card, read only memory (ROM), or the like.

The input/output interface 1100 is an interface connecting the computer 1000 and an input/output device. For example, an input device such as a keyboard and an output device such as a display device are connected to the input/output interface 1100.

The network interface 1120 is an interface connecting the computer 1000 to a network. The network may be a local area network (LAN) or a wide area network (WAN).

The storage device 1080 stores a program (a program for implementing the above-described application) for implementing each functional component of the abnormality detection device 2000. The processor 1040 reads the program to the memory 1060 and executes the program to implement each functional component of the abnormality detection device 2000.

The abnormality detection device 2000 may be implemented by one computer 1000 or may be implemented by the plurality of computers 1000. In the latter case, the configurations of the computers 1000 do not need to be the same, and can be different from each other.

### <Flow of Processing>

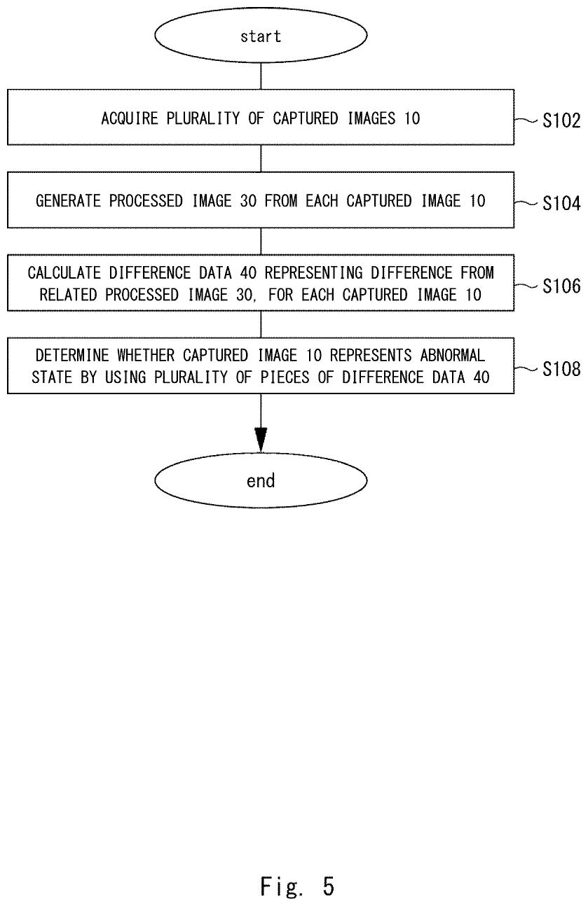

FIG. 5 is a flowchart illustrating a flow of processing executed by the abnormality detection device 2000 of the present example embodiment. The generation unit 2020 acquires the plurality of captured images 10 (S102). The calculation unit 2040 generates the processed image 30 from each captured image 10 (S104). The calculation unit 2040 calculates the difference data 40 representing the difference from the related processed image 30, for each captured image 10 (S106). The determination unit 2060 determines whether a scene represented by the captured image 10 represents a predetermined situation, by using the plurality of pieces of calculated difference data 40 (S108).

### <Acquisition of Captured Image 10: S102>

The generation unit 2020 acquires the captured image 10 (S102). Here, various methods can be adopted as a method of acquiring a captured image generated by a camera. For example, the camera 20 stores each captured image 10, in a storage unit that is accessible from the abnormality detection device 2000. The generation unit 2020 acquires each captured image 10 from the storage unit. In addition, for example, the camera 20 may be configured to transmit the captured image 10 to the abnormality detection device 2000. In this case, the generation unit 2020 acquires the captured image 10, by receiving the captured image 10 transmitted from the camera 20.

Here, the generation unit 2020 may acquire the captured images 10 one by one or may acquire the plurality of captured images 10 at a time. In the latter case, for example, the generation unit 2020 periodically accesses the storage unit that stores the captured image 10 and collectively acquires unacquired captured images 10.

### <Generation of Processed Image 30: S104>

The generation unit 2020 generates the processed image 30 from each captured image 10 (S104). As described above, the processing for generating the processed image 30 from the captured image 10 includes the mask processing and the restoration processing. Hereinafter, each of the mask processing and the restoration processing will be described.

### <<Regarding Mask Processing>>

The generation unit 2020 masks one or more partial regions of the captured image 10. Hereinafter, a region to be masked is also referred to as a mask target region. Here, various methods can be adopted to a method of masking a specific region on an image. For example, the generation unit 2020 generates the intermediate image 50 in which each mask target region is masked, by changing a value of each pixel of the mask target region to a predetermined value (for example, 0 or 1), in the captured image 10. Note that a method of specifying the mask target region will be described later. In addition, for example, the generation unit 2020 may generate the intermediate image 50, by executing processing for superimposing the captured image 10 and a mask image in which arrangement of the mask target region is determined. Here, an existing technique can be used for a technique for executing the mask processing on a specific image using an image for mask. The mask image will be described later.

Various methods can be adopted to a method of specifying the mask target region. For example, the generation unit 2020 randomly specifies one or more partial regions from the captured image 10 and treats each specified partial region as the mask target region. The number of mask target regions to be specified from the single captured image 10, a shape of the mask target region, and a size of the mask target region are determined in advance, for example. Hereinafter, the number of mask target regions is set to Nm. In this case, the generation unit 2020 randomly specifies positions of Nm regions from the captured image 10. Moreover, the generation unit 2020 specifies a partial region having a predetermined shape and a predetermined size, for each of the Nm specified positions as a reference position (for example, a center, a position on an upper left end, or the like). Then, the generation unit 2020 treats each of the Nm specified partial regions, as the mask target region.

Here, the plurality of mask target regions may be specified so as to permit overlapping with each other or may be specified so as not to overlap with each other. In the latter case, for example, the generation unit 2020 randomly specifies the Nm mask target regions in order. Then, in a case where the newly specified mask target region overlaps the mask target region that has already been specified, the generation unit 2020 prevents the new mask target region from overlapping the mask target region that has already been specified, by executing the processing for randomly specifying the new mask target region again.

One or more of the number of mask target regions, the shape of the mask target region, and the size of the mask target region may be randomly determined.

In addition, for example, the mask target region may be specified by using a mask image that indicates the arrangement of the mask target region. For example, in the mask image, a value of each pixel of an image region treated as the mask target region is 0, and a value of each pixel of another image region is 1.

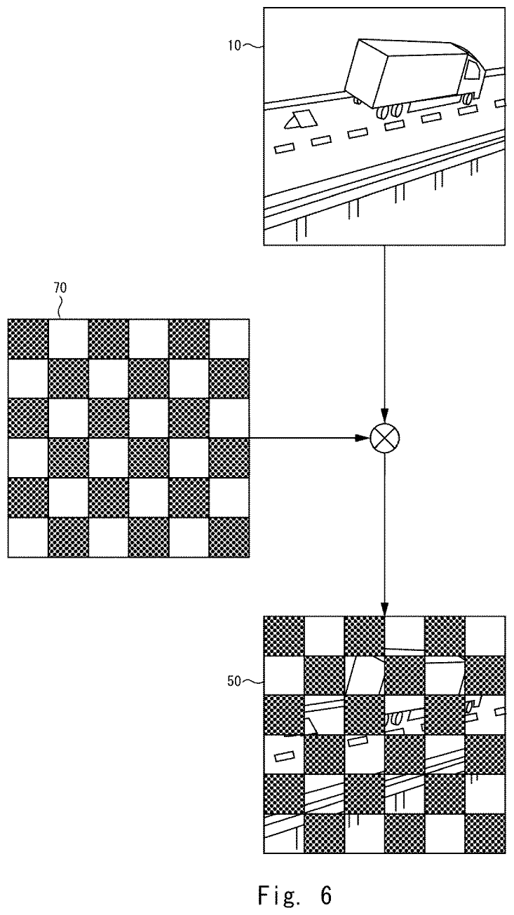

FIG. 6 is a diagram illustrating the mask processing using the mask image. In FIG. 6, the mask target region is represented by a dot pattern. In a mask image 70 in FIG. 6, the mask target region is defined by a check pattern.

Sizes of the mask image and the captured image 10 may be the same as each other or may be different from each other. In the latter case, the generation unit 2020 enlarges or reduces the mask image so as to have a size that matches the size of the captured image 10.

The mask target region may be specified based on a predetermined rule (hereinafter, a mask rule). For example, a rule such that “dividing the captured image 10 by My in the longitudinal direction and dividing the captured image 10 by Mh in the lateral direction, setting partial regions in odd-numbered columns as the mask target regions in odd-numbered rows, and setting partial regions in even-numbered columns as the mask target regions in even-numbered rows” is used. In accordance with this rule, the arrangement of the mask target region is expressed as a check pattern.

The number of divisions in the longitudinal direction and the lateral direction may be determined in advance or may be randomly determined. In addition, for example, the number of divisions in the longitudinal direction and the lateral direction may be determined, based on a predetermined size of the partial region. Specifically, if the size of the captured image 10 in the lateral direction is set to We and the size of the partial region in the lateral direction is set to Wp, the number of divisions in the lateral direction is a minimum integer equal to or more than Wc/Wp. The number of divisions in the longitudinal direction can be calculated by a similar method.

Instead of the above-described rule such that “the partial regions in the odd-numbered rows and odd-numbered columns and the partial regions in the even-numbered rows and the even-numbered columns are treated as the mask target regions”, a rule such that “partial regions in the odd-numbered rows and the even-numbered columns and a partial regions in the even-numbered rows and the odd-numbered columns are treated as the mask target regions” may be used. The rule for determining the mask target region is not limited to the rule for expressing the check pattern and can be any rule.

The generation unit 2020 may set a common mask target region for all the captured images 10 or does not need to set the common mask target region. In the former case, for example, the generation unit 2020 executes mask processing using the same mask image or mask rule, on all the captured images 10.

In a case where the common mask target region is not set for all the captured images 10, for example, the generation unit 2020 randomly specifies the mask target region for each captured image 10. In addition, for example, the generation unit 2020 alternately applies two mask images or two mask rules on the time-series captured images 10.

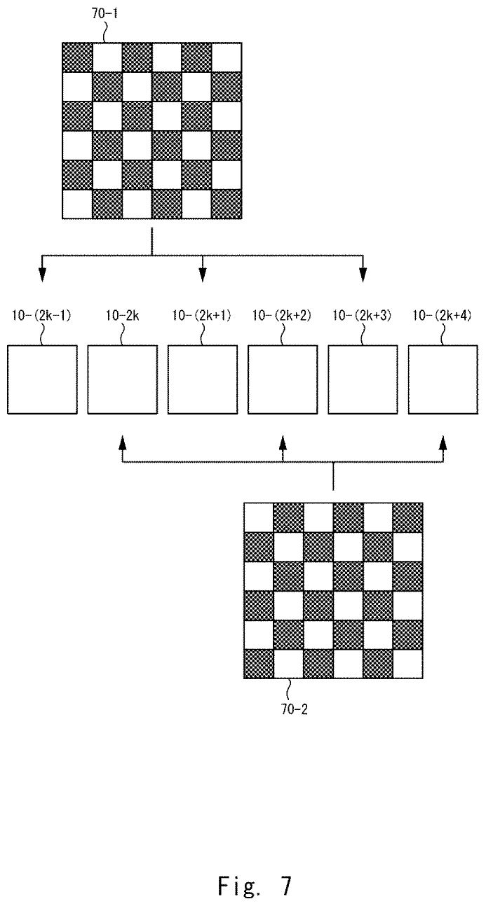

FIG. 7 is a diagram illustrating a case where the two mask images are alternately applied. Here, a sign of an i-th captured image 10 in a chronological order is represented as “10-i”. In FIG. 7, on an even numbered captured image 10 in the chronological order, mask processing using a mask image 70-1 is executed. On the other hand, on an odd numbered captured image 10 in the chronological order, mask processing using a mask image 70-2 is executed.

Here, it is preferable that the two mask images 70-1 and 70-2 satisfy a relationship “a partial region treated as the mask target region in the mask image 70-1 is not treated as the mask target region in the mask image 70-2, and a partial region that is not treated as the mask target region in the mask image 70-1 is treated as the mask target region in the mask image 70-2”. In a case where the mask image is achieved by a binary image, by executing processing for inverting 0 and 1 on the mask image 70-1, the mask image 70-2 is obtained. The mask images 70-1 and 50-2 satisfy this relationship so that it is possible to equalize frequencies at which the respective partial regions of the captured images 10 are masked.

The numbers of mask images and mask rules are not limited to 2 or may be equal to or more than 3. For example, in a case where three mask images are used, a mask image M1 applied to a (3k−2)-th captured image 10 in the chronological order, a mask image M2 applied to a (3k−1)-th captured image 10 in the chronological order, and a mask image M3 applied to a 3k-th captured image 10 in the chronological order are prepared in advance. Here, k is a natural number.

The generation unit 2020 may detect an object that is normally included in the captured image 10 (in other words, captured by the camera 20) from the captured image 10 and does not need to include an image region representing the object in the mask target region. Hereinafter, the object that is normally included in the captured image 10 is also referred to as a “normal object”. An image region representing the normal object is also referred to as a “normal region”.

For example, it is assumed that the camera 20 be a camera that monitors a road. In this case, the normal object is a vehicle or the like. In addition, for example, it is assumed that the camera 20 be a camera that monitors inside of a facility used by a person. In this case, the normal object is a person or the like.

Here, for a technique for detecting a specific type of object from an image, an existing technique can be used. It is assumed that the type of the object to be detected as the normal object be determined in advance.

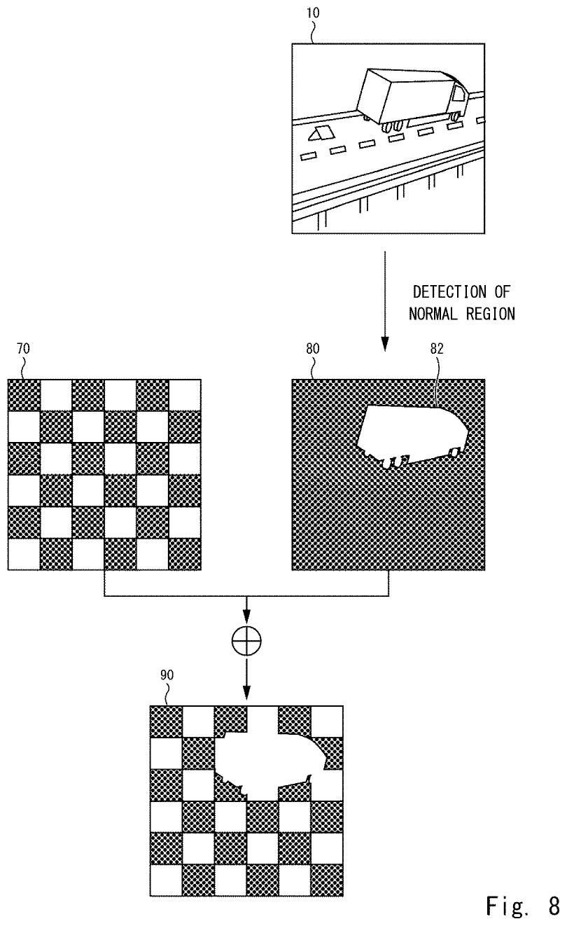

FIG. 8 is a diagram illustrating a case where the normal region is excluded from the mask target region. In this example, the normal object is a vehicle. Therefore, a normal region 82 representing a vehicle is detected from the captured image 10.

The generation unit 2020 generates a new mask image 90, by superimposing the mask image 70 prepared in advance and an image 80 representing arrangement of the normal region 82. A region represented by the mask image 90 as the mask target region is the mask target region in the mask image 70 and is not included in the normal region 82. The generation unit 2020 executes the mask processing on the captured image 10 by using the mask image 90.

The method for excluding the normal region from the mask target region is not limited to the method using the mask image. For example, the generation unit 2020 may specify the mask target region, by randomly specifying a partial region from an image region excluding the normal region.

Excluding the normal region from the mask target region has an effect of reducing erroneous determination by the determination unit 2060. In a case where the restoration processing is executed on the intermediate image 50 in which the normal region is masked, there is a possibility that it is not possible to accurately restore the normal region. Then, in a case where it is not possible to accurately restore the normal region, due to a difference in the normal region between the captured image 10 and the processed image 30, there is a possibility that it is erroneously determined that the captured image 10 represents an abnormal state. By excluding the normal region from the mask target region, such occurrence of the erroneous determination caused by a fact that it is not correctly restore the masked normal region can be prevented.

### <<Regarding Restoration Processing>>

The generation unit 2020 generates the processed image 30, by executing the restoration processing on the intermediate image 50. The restoration processing is executed, for example, by using a machine learning model such as a neural network. Hereinafter, the machine learning model used for the restoration processing is also referred to as a restoration model. The restoration model is trained in advance so as to output an image in which the image region is restored, in response to an input of an image including the masked image region. The generation unit 2020 inputs the intermediate image 50 in the restoration model and uses the image output from the restoration model, as the processed image 30.

The restoration model is trained by using a plurality of pieces of training data. The training data includes a ground truth (ground-truth) image before the mask processing is executed and a training input image obtained by masking one or more partial regions in the ground truth image. A device (hereinafter, a training device) that trains the restoration model inputs, for example, the training input image in the restoration model and calculates a loss based on the image output from the restoration model and the ground truth image. Then, the training device trains the restoration model, by updating a trainable parameter of the restoration model based on the loss.

The training device does not need to include the normal region described above (the region representing the normal object such as a vehicle) in a loss calculation target. Specifically, when calculating the loss by using a value of each pixel in the training input image and the image output from the restoration model, the training device excludes a value of each pixel included in the normal region, from a calculation target.

Here, the training input image used to train the restoration model may be an image generated by the camera 20 or may be an image generated by another camera.

For example, SimMIM disclosed in NPL 1 can be used for the restoration model. However, the restoration model is not limited to the SimMIM, and various machine learning models can be used.

### <Calculation of Difference Data 40: S106>

The calculation unit 2040 calculates the difference data 40 representing the difference between the captured image 10 and the processed image 30 generated from the captured image 10, for each of the plurality of captured images 10 (S106). Here, various methods can be used to calculate the difference data 40 representing the difference between the two images. For example, the calculation unit 2040 calculates a difference value between pixel values of pixels related to each other, between the captured image 10 and the processed image 30. Then, the calculation unit 2040 calculates a total value of the difference values calculated for the respective pixels, as the difference data 40.

Here, in a case where the captured image 10 and the processed image 30 are single-channel images (for example, a grayscale image), the pixel value of each pixel is a scalar value. Therefore, a difference value between the pixels related to each other is obtained by calculating a difference between two scalar values.

On the other hand, in a case where the captured image 10 and the processed image 30 are multiple-channel images (for example, an RGB image), the value of each pixel is a vector including a value for each channel. Therefore, the difference value between the pixels related to each other is obtained by calculating a norm of two vectors. For example, it is assumed that a pixel value of coordinates (x, y) in the captured image 10 be (r1, g1, b1) and a pixel value of coordinates (x, y) in the processed image 30 be (r2, g2, b2). In this case, a difference value calculated for the pixel of the coordinates (x, y) is represented by a norm of a vector (r1, g1, b1) and a vector (r2, g2, b2).

The difference data 40 between the captured image 10 and the processed image 30 is not limited to the total value of the pixel values. For example, the difference data 40 between the captured image 10 and the processed image 30 may be an average value of the pixel value.

The calculation unit 2040 may exclude the normal region described above from a calculation target of the difference data 40. In this way, in the determination by the determination unit 2060, the difference between the captured image 10 and the processed image 30 in the normal region is not considered. Therefore, even in a case where it is not possible to accurately restore the masked normal region, it is possible to accurately determine whether the captured image 10 represents the abnormal state.

By performing one of exclusion of the normal region from the mask target region or exclusion of the normal region from the calculation target of the difference data 40, in the determination by the determination unit 2060, it is possible not to consider the difference between the captured image 10 and the processed image 30 in the normal region. Therefore, in a case where the normal region is excluded from the mask target region, it is not necessary to exclude the normal region from the calculation target of the difference data 40.

### <Abnormality Detection: S108>

The determination unit 2060 determines whether the captured image 10 represents the abnormal state, by using the difference data 40 calculated for each of the plurality of captured images 10 (S108). Therefore, for example, the determination unit 2060 calculates an index value representing a change degree of a situation between before and after each of a plurality of time points. Hereinafter, this index value is also referred to as a “situation change degree”. In a case where a situation change degree for a certain time point is calculated, the time point is also referred to as a reference time point of the situation change degree.

The determination unit 2060 determines whether the situation change degree calculated for each reference time point is equal to or more than a threshold. In a case where a situation change degree calculated for a certain reference time point is equal to or more than the threshold, the determination unit 2060 determines that the captured image 10 at the reference time point represents the abnormal state.

The situation change degree at the certain reference time point is calculated, for example, based on difference data 40 calculated for a first period having a predetermined length including a time point before the reference time point and difference data 40 calculated for a second period having a predetermined length including a time point after the reference time point. The reference time point may be included in one or both of the first period and the second period.

For example, the situation change degree is calculated by the following formula (1).

$$\begin{matrix}[ Equation 1 ] & \\ D ( r ) = \frac{V 2 ( r )}{V 1 ( r )} & ( 1 )\end{matrix}$$

$$V 1 ( r ) = \frac{1}{L 1 + 1} * {\sum }_{i = r - L 1}^{r} {S}_{i}$$

$$V 2 ( r ) = \frac{1}{L 2 + 1} {\sum }_{i = r}^{r + L 2} {S}_{i}$$

Here, D (r) represents a situation change degree at a reference time point r. In the formula (1), the time point is represented by a discrete value (for example, a frame number) allocated in ascending order of a generation time point for each captured image 10. V1 (r) represents an average value of the difference data 40 calculated for each of (L1+1) captured images 10 included in a period having a length L1 and having a time point r as an end point. V2 (r) represents an average value of the difference data 40 calculated for each of (L2+1) captured images 10 included in a period having a length L2 and having the time point r as a start point. The reference Si represents difference data 40 calculated for a captured image 10 at a time point i.

L1 and L2 may be the same as each other or may be different from each other. In a case of L1=L2, the total value of the difference data 40 may be used for V1 (r) and V2 (r), instead of the average value of the difference data 40.

Here, V1 (r) represents a magnitude of the difference between the captured image 10 and the processed image 30, in the near past with the time point r as a reference. On the other hand, V2 (r) represents a magnitude of the difference between the captured image 10 and the processed image 30, in the near future with the time point r as a reference. Therefore, a fact that V2 (r) is sufficiently larger than V1 (r) indicates that the difference between the captured image 10 and the processed image 30 increases at the time point r or a time point around the time point r as a boundary and a situation where the difference is large continues. Therefore, the fact that V2 (r) is sufficiently larger than V1 (r) indicates that a situation indicated by the captured image 10 (that is, a situation of a place imaged by the camera 20) changes at the time point r or the time point around the time point r as the boundary.

For example, it is assumed that a foreign object falls on a road at the certain time point r. In this case, while the foreign object does not exist on the road in the past closer than the time point r and the foreign object exists on the road in the future closer than the time point r. Therefore, while the difference between the captured image 10 and the processed image 30 is small in a period before the time point r, the difference between the captured image 10 and the processed image 30 is large in a period after the time point r.

In addition, for example, it is assumed that baggage be left at the time point r. In this case, while the left object does not exist in the past closer than the time point r, the left object exists in the future closer than the time point r. Therefore, while the difference between the captured image 10 and the processed image 30 is small in the period before the time point r, the difference between the captured image 10 and the processed image 30 is large in the period after the time point r.

From this, by comparing the situation change degree with the threshold, the abnormal state can be detected.

Here, instead of using an integrated value of the pieces of difference data 40 at the plurality of time points as indicated by the formula (1), a method is considered of comparing the difference data 40 at the reference time point with difference data 40 at a time point immediately before the reference time point (for example, determine whether S_i/S_(i−1) is equal to or more than the threshold). However, this method is likely to be affected by noise that is temporarily generated. On the other hand, as indicated by the formula (1), according to the method of integrating and comparing the pieces of difference data 40 in periods having a certain length before and after the reference time point, the influence of the temporary noise is less likely to be received. Therefore, according to the method described above, it is possible to accurately determine whether the captured image 10 represents the abnormal state.

Here, as the value of the length L2 in the close future viewed from the reference time point r is increased, a longer future situation is considered. Therefore, in a case where a situation of the observation range only changes only in a short time period, so as not to prevent the observation range from being determined to be in the abnormal state, it is preferable that the length L2 be increased to be sufficiently larger.

For example, it is assumed that a situation where “the left object exists” be treated as the abnormal state of the observation range. In this case, it is preferable that a situation where “a person temporarily places one's belongings on the ground” be not detected as the abnormal state. Therefore, it is preferable to identify the object temporarily placed on the ground and the left object, by setting an appropriate value to the length L2. By using another method of analyzing the captured image 10 and associating a person with an object in combination, the presence of the left object may be accurately detected.

### <Output of Information Regarding Abnormality Detection>

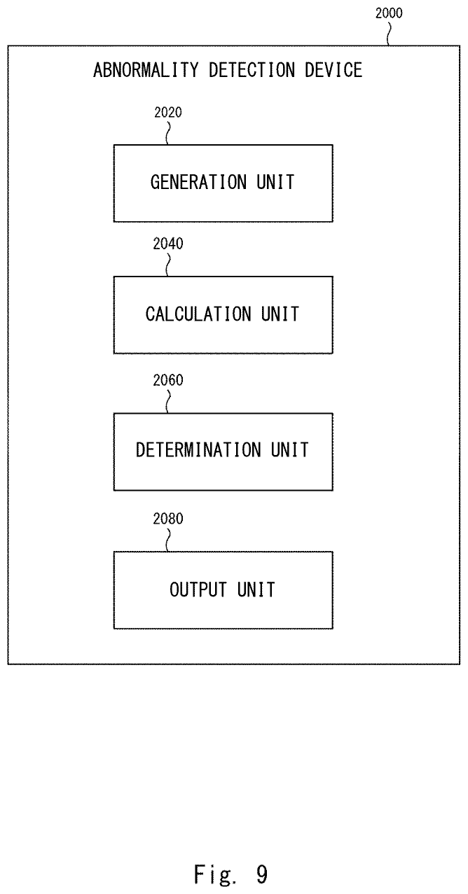

The abnormality detection device 2000 preferably outputs information regarding a determination result by the determination unit 2060. Hereinafter, a functional component that outputs the information regarding the determination result is referred to as an output unit. FIG. 9 is a diagram illustrating a functional configuration of the abnormality detection device 2000 including an output unit 2080.

For example, the output unit 2080 displays a screen that sequentially displays the captured images 10 generated by the camera 20 in times series, on any display device. Hereinafter, this screen is referred to as an observation screen. In a case where the camera 20 is a video camera, video data generated by the camera 20 is displayed on the observation screen.

On the observation screen, various types of information are displayed, in addition to the captured image 10. For example, in a case where the determination unit 2060 determines that the captured image 10 represents the abnormal state (in other words, the observation range is in the abnormal state), on the observation screen, some kind of display is added so that a user of the abnormality detection device 2000 can perceive the determination result. For example, the output unit 2080 includes, in the observation screen, a predetermined message, mark, or the like indicating that the observation range is in the abnormal state. Hereinafter, the user of the abnormality detection device 2000 is also simply referred to as a user.

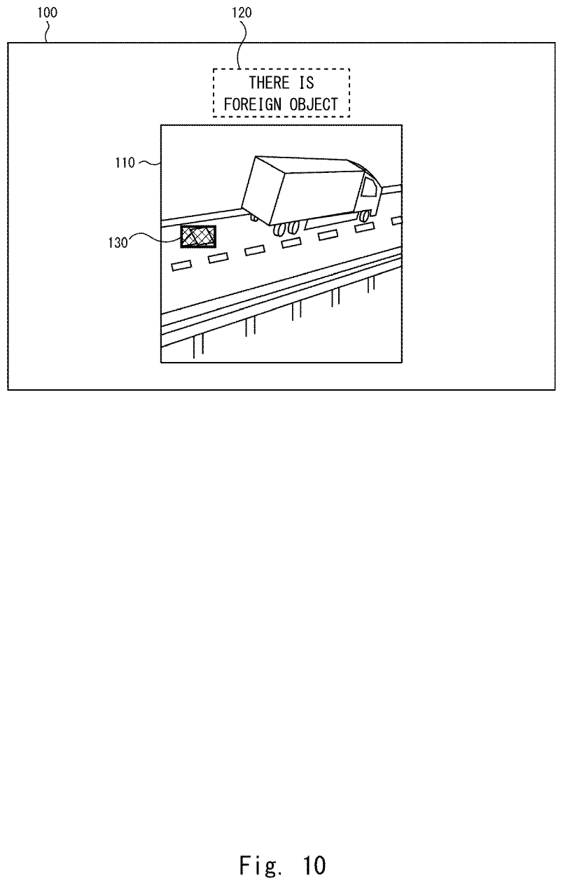

FIG. 10 is a diagram illustrating an observation screen including a display indicating that the observation range is in the abnormal state. An observation screen 100 includes an image display area 110. In the image display area 110, the captured images 10 generated by the camera 20 are displayed in the chronological order.

In the example in FIG. 10, the observation range is a road. Then, the abnormal state is a situation where a foreign object (for example, a falling object) exists on the road.

When the foreign object is generated in the observation range, a situation change degree having a time point when the foreign object is generated or a time point therearound as the reference time point becomes equal to or more than the threshold. As a result, the determination unit 2060 determines that “the road to be observed is in a situation where a foreign object exists”. Therefore, the output unit 2080 displays a message 120 “there is a foreign object”, on the observation screen 100, in response to the determination.

The output unit 2080 may include, in the observation screen, a display indicating a position of an object (hereinafter, an abnormal object) that contributes to the observation range in the abnormal state, such as the foreign object in the example in FIG. 10. For example, on the observation screen 100 in FIG. 10, a mark 130 indicating a position of the detected foreign object is displayed on the captured image 10.

In the captured image 10, an image region representing the abnormal object is an image region in which the difference between the captured image 10 and the processed image 30 is large. As described above, when the difference data 40 is calculated for each captured image 10, a difference value between related pixels is calculated between the captured image 10 and the processed image 30 generated from the captured image 10.

Therefore, the output unit 2080 specifies a difference value of which a magnitude is equal to or more than the threshold, from among the difference values between the pixels calculated for the captured image 10 of which the situation change degree is equal to or more than the threshold and the processed image 30 generated from the captured image 10. Then, the output unit 2080 specifies an image region including each pixel of which the difference value is equal to or more than the threshold, as an image region (hereinafter, an abnormal region) representing the abnormal object.

Here, in order to prevent noise from being recognized as the abnormal region, a lower limit value of a size of the abnormal region may be determined. In this case, the output unit 2080 specifies an image region including each pixel in which the difference value between the captured image 10 and the processed image 30 is equal to or more than the threshold and an image region having a size equal to or more than a predetermined lower limit value, as the abnormal region.

In order to allow the user to easily perceive the abnormal object, it is preferable for the output unit 2080 to continue displaying the message 120 or the mark 130 (hereinafter, the message 120 or the like) on the observation screen 100 for a certain time period. For example, the output unit 2080 displays the message 120 or the like on the observation screen 100 for the predetermined time period, in response to the determination that the observation range is in the abnormal state.

In addition, for example, the output unit 2080 may determine whether to continue displaying the message 120 or the like on the observation screen 100, based on the situation change degree. Specifically, if it is determined that the situation change degree at the certain reference time point is equal to or more than the threshold, the output unit 2080 specifies the abnormal region and records association between the abnormal region and the situation change degree. Moreover, the output unit 2080 attenuates the situation change degree related to the abnormal region over time. The situation change degree attenuated over time represents a degree at which a notification such as the message 120 needs to continue. Therefore, the situation change degree attenuated over time is also expressed as a notification necessity.

The output unit 2080 determines whether the message 120 or the like related to the abnormal region is included in the observation screen 100, in accordance with the notification necessity related to the abnormal region. For example, while the notification necessity related to the abnormal region is equal to or more than the threshold, the output unit 2080 displays the message 120 or the like related to the abnormal region on the observation screen 100.

In addition, for example, the output unit 2080 may compare the notification necessity related to the abnormal region with a newly calculated situation change degree. In a case where the notification necessity related to the abnormal region is larger than the newly calculated situation change degree, the output unit 2080 displays the message 120 or the like related to the abnormal region on the observation screen 100. On the other hand, in a case where the notification necessity related to the abnormal region is equal to or less than the newly calculated situation change degree, the output unit 2080 ends the display of the message 120 or the like related to the abnormal region.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

In the above-described example, the program includes a group of instructions (or a software code) for causing a computer to perform one or more functions described in the example embodiments when being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted through a transitory computer-readable medium or a communication medium. As an example and not by way of limitation, a transitory computer-readable or communication medium includes electrical, optical, acoustic, or other forms of propagated signals.

### (Supplementary Note 1)

An abnormality detection device comprising:
generation means for generating a plurality of processed images, by processing each of a plurality of time-series captured images;
calculation means for calculating difference data representing a difference between the captured image and the processed image generated from the captured image, for each of the plurality of captured images; and
determination means for determining whether the captured image represents an abnormal state, based on a plurality of pieces of the calculated difference data,
wherein the processing executed on the captured image includes mask processing for masking one or more partial regions included in the captured image and restoration processing for restoring the masked partial region by using data other than the partial region.

### (Supplementary Note 2)

The abnormality detection device according to supplementary note 1,
wherein the calculation means performs:
detecting, from the captured image, an image region representing a predetermined type of object that is not abnormal to be present in the captured image; and
calculating the difference data by calculating a difference between the captured image and the processed image generated from the captured image, for an image region excluding the detected image region.

### (Supplementary Note 3)

The abnormality detection device according to supplementary note 1, wherein the calculation means detects an image region representing a predetermined type of object from the captured image and excludes the detected image region from a target of the masking.

### (Supplementary Note 4)

The abnormality detection device according to any one of supplementary notes 1 to 3, further comprising a restoration model that has been trained to output, in response to an input of an image including a masked image region, an image in which the masked image region is restored,
wherein the calculation means executes the restoration processing by inputting the captured image in which the partial region is masked by the mask processing, into the restoration model, and
wherein, in a training of the restoration model, the image region representing the predetermined type of the object that is not abnormal to be present in the captured image is not included in a target of loss calculation.

### (Supplementary Note 5)

The abnormality detection device according to any one of supplementary notes 1 to 3,
wherein the determination means performs:
calculating, for each of reference time points, a situation change degree representing a ratio of a statistical value of the difference data calculated for each of the plurality of captured images generated in a period after the reference time point, with respect to a statistical value of the difference data calculated for each of the plurality of captured images generated in a period before the reference time point; and
determining, in a case where the situation change degree calculated for the reference time point is equal to or more than a threshold, that the captured image generated at the reference time point represents an abnormal state.

### (Supplementary Note 6)

The abnormality detection device according to supplementary note 5, further comprising output means for outputting a screen including the captured image,
wherein the output means attenuates the situation change degree over time after it is determined that the situation change degree calculated for the reference time point is equal to or more than the threshold, and includes, in the screen, a display indicating that the captured image represents the abnormal state, while the attenuated situation change degree is equal to or more than the situation change degree calculated for the newly acquired captured image.

### (Supplementary Note 7)

An abnormality detection method executed by a computer comprising:
a generation step for generating a plurality of processed images, by processing each of a plurality of time-series captured images;
a calculation step for calculating difference data representing a difference between the captured image and the processed image generated from the captured image, for each of the plurality of captured images; and
a determination step for determining whether the captured image represents an abnormal state, based on a plurality of pieces of the calculated difference data,
wherein the processing executed on the captured image includes mask processing for masking one or more partial regions included in the captured image and restoration processing for restoring the masked partial region by using data other than the partial region.

### (Supplementary Note 8)

The abnormality detection device according to supplementary note 7,
wherein, in the calculation step:
detecting, from the captured image, an image region representing a predetermined type of object that is not abnormal to be present in the captured image; and
calculating the difference data by calculating a difference between the captured image and the processed image generated from the captured image, for an image region excluding the detected image region.

### (Supplementary Note 9)

The abnormality detection method according to supplementary note 7, wherein, in the calculation step, detecting an image region representing a predetermined type of object from the captured image, and excluding the detected image region from a target of the masking.

### (Supplementary Note 10)

The abnormality detection method according to any one of supplementary notes 7 to 9,
wherein the computer includes a restoration model that has been trained to output, in response to an input of an image including a masked image region, an image in which the masked image region is restored,
wherein, in the calculation step, executing the restoration processing by inputting the captured image in which the partial region is masked by the mask processing, into the restoration model, and
wherein, in a training of the restoration model, the image region representing the predetermined type of the object that is not abnormal to be present in the captured image is not included in a target of loss calculation.

### (Supplementary Note 11)

The abnormality detection method according to any one of supplementary notes 7 to 9,
wherein, in the determination step:
calculating, for each of reference time points, a situation change degree representing a ratio of a statistical value of the difference data calculated for each of the plurality of captured images generated in a period after the reference time point, with respect to a statistical value of the difference data calculated for each of the plurality of captured images generated in a period before the reference time point; and
determining, in a case where the situation change degree calculated for the reference time point is equal to or more than a threshold, that the captured image generated at the reference time point represents an abnormal state.

### (Supplementary Note 12)

The abnormality detection method according to supplementary note 11, further comprising an output step for outputting a screen including the captured image,
wherein, in the output step, attenuating the situation change degree over time after it is determined that the situation change degree calculated for the reference time point is equal to or more than the threshold, and including, in the scree, a display indicating that the captured image represents the abnormal state, while the attenuated situation change degree is equal to or more than the situation change degree calculated for the newly acquired captured image.

### (Supplementary Note 13)

A program for causing a computer to execute processing comprising:
a generation step for generating a plurality of processed images, by processing each of a plurality of time-series captured images;
a calculation step for calculating difference data representing a difference between the captured image and the processed image generated from the captured image, for each of the plurality of captured images; and
a determination step for determining whether the captured image represents an abnormal state, based on a plurality of pieces of the calculated difference data,
wherein the processing executed on the captured image includes mask processing for masking one or more partial regions included in the captured image and restoration processing for restoring the masked partial region by using data other than the partial region.

### (Supplementary Note 14)

The program according to supplementary note 13,
wherein, in the calculation step:
detecting, from the captured image, an image region representing a predetermined type of object that is not abnormal to be present in the captured image; and
calculating the difference data by calculating a difference between the captured image and the processed image generated from the captured image, for an image region excluding the detected image region.

### (Supplementary Note 15)

The program according to supplementary note 13, wherein, in the calculation step, detecting an image region representing a predetermined type of an object from the captured image, and the detected image region is excluded from a mask target.

### (Supplementary Note 16)

The program according to any one of supplementary notes 13 to 15, further comprising a restoration model that has been trained to output, in response to an input of an image including a masked image region, an image in which the masked image region is restored,
wherein, in the calculation step, executing the restoration processing by inputting the captured image in which the partial region is masked by the mask processing, into the restoration model, and
wherein, in a training of the restoration model, the image region representing the predetermined type of the object that is not abnormal to be present in the captured image is not included in a target of loss calculation.

### (Supplementary Note 17)

The program according to any one of supplementary notes 13 to 15,
wherein, in the determination step:
calculating, for each of reference time points, a situation change degree representing a ratio of a statistical value of the difference data calculated for each of the plurality of captured images generated in a period after the reference time point, with respect to a statistical value of the difference data calculated for each of the plurality of captured images generated in a period before the reference time point; and
determining, in a case where the situation change degree calculated for the reference time point is equal to or more than a threshold, that the captured image generated at the reference time point represents an abnormal state.

### (Supplementary Note 18)

The program according to supplementary note 17, for causing the computer to execute processing further comprising an output step for outputting a screen including the captured image,
wherein, in the output step, attenuating the situation change degree over time after it is determined that the situation change degree calculated for the reference time point is equal to or more than the threshold, and including, in the screen, a display indicating that the captured image represents the abnormal state, while the attenuated situation change degree is equal to or more than the situation change degree calculated for the newly acquired captured image.

This application is based upon and claims the benefit of priority from Japanese patent application No. 2023-009536, filed on Jan. 25, 2023, the disclosure of which is incorporated herein in its entirety by reference.

### REFERENCE SIGNS LIST

10 captured image
20 camera
30 processed image
40 difference data
50 intermediate image
60 falling object
70 mask image
80 image
82 normal region
90 mask image
100 observation screen
110 image display area
120 message
130 mark
1000 computer
1020 bus
1040 processor
1060 memory
1080 storage device
1100 input/output interface
1120 network interface
2000 abnormality detection device
2020 generation unit
2040 calculation unit
2060 determination unit
2080 output unit

What is claimed is:

1. An abnormality detection device comprising:
at least one memory that is configured to store instructions; and
at least one processor that is configured to execute the instructions to:
generate a plurality of processed images, by processing each of a plurality of time-series captured images;
calculate difference data representing a difference between the captured image and the processed image generated from the captured image, for each of the plurality of captured images; and
determine whether the captured image represents an abnormal state, based on a plurality of pieces of the calculated difference data,
wherein the processing executed on the captured image includes mask processing for masking one or more partial regions included in the captured image and restoration processing for restoring the masked partial region by using data other than the partial region.

2. The abnormality detection device according to claim 1,
wherein the calculation of the difference data includes:
detecting, from the captured image, an image region representing a predetermined type of object that is not abnormal to be present in the captured image; and
calculating the difference data by calculating a difference between the captured image and the processed image generated from the captured image, for an image region excluding the detected image region.

3. The abnormality detection device according to claim 1, wherein the calculation of the difference data includes detecting an image region representing a predetermined type of object from the captured image and excluding the detected image region from a target of the masking.

4. The abnormality detection device according to claim 1,
wherein the at least one memory further stores a restoration model that has been trained to output, in response to an input of an image including a masked image region, an image in which the masked image region is restored,
wherein the calculation of the difference data includes executing the restoration processing by inputting the captured image in which the partial region is masked by the mask processing, into the restoration model, and
wherein, in a training of the restoration model, the image region representing the predetermined type of the object that is not abnormal to be present in the captured image is not included in a target of loss calculation.

5. The abnormality detection device according to claim 1,
wherein the determination of whether the captured image represents an abnormal state includes:
calculating, for each of reference time points, a situation change degree representing a ratio of a statistical value of the difference data calculated for each of the plurality of captured images generated in a period after the reference time point, with respect to a statistical value of the difference data calculated for each of the plurality of captured images generated in a period before the reference time point; and
determining, in a case where the situation change degree calculated for the reference time point is equal to or more than a threshold, that the captured image generated at the reference time point represents an abnormal state.

6. The abnormality detection device according to claim 5,
wherein the at least one processor is configured further to output a screen including the captured image,
wherein the output of the screen includes attenuating the situation change degree over time after it is determined that the situation change degree calculated for the reference time point is equal to or more than the threshold, and including, in the screen, a display indicating that the captured image represents the abnormal state, while the attenuated situation change degree is equal to or more than the situation change degree calculated for the newly acquired captured image.

7. An abnormality detection method executed by a computer comprising:
generating a plurality of processed images, by processing each of a plurality of time-series captured images;
calculating difference data representing a difference between the captured image and the processed image generated from the captured image, for each of the plurality of captured images; and
determining whether the captured image represents an abnormal state, based on a plurality of pieces of the calculated difference data,
wherein the processing executed on the captured image includes mask processing for masking one or more partial regions included in the captured image and restoration processing for restoring the masked partial region by using data other than the partial region.

8. The abnormality detection device according to claim 7,
wherein the calculation of the difference data includes:
detecting, from the captured image, an image region representing a predetermined type of object that is not abnormal to be present in the captured image; and
calculating the difference data by calculating a difference between the captured image and the processed image generated from the captured image, for an image region excluding the detected image region.

9. The abnormality detection method according to claim 7, wherein the calculation of the difference data includes detecting an image region representing a predetermined type of object from the captured image, and excluding the detected image region from a target of the masking.

10. The abnormality detection method according to claim 7,
wherein the computer includes a restoration model that has been trained to output, in response to an input of an image including a masked image region, an image in which the masked image region is restored,
wherein the calculation of the difference data includes executing the restoration processing by inputting the captured image in which the partial region is masked by the mask processing, into the restoration model, and
wherein, in a training of the restoration model, the image region representing the predetermined type of the object that is not abnormal to be present in the captured image is not included in a target of loss calculation.

11. The abnormality detection method according to claim 7,
wherein the determination of whether the captured image represents an abnormal state includes:
calculating, for each of reference time points, a situation change degree representing a ratio of a statistical value of the difference data calculated for each of the plurality of captured images generated in a period after the reference time point, with respect to a statistical value of the difference data calculated for each of the plurality of captured images generated in a period before the reference time point; and
determining, in a case where the situation change degree calculated for the reference time point is equal to or more than a threshold, that the captured image generated at the reference time point represents an abnormal state.

12. The abnormality detection method according to claim 11, further comprising outputting a screen including the captured image,
wherein the output of the screen includes attenuating the situation change degree over time after it is determined that the situation change degree calculated for the reference time point is equal to or more than the threshold, and including, in the scree, a display indicating that the captured image represents the abnormal state, while the attenuated situation change degree is equal to or more than the situation change degree calculated for the newly acquired captured image.

13. A non-transitory computer-readable medium storing a program for causing a computer to execute processing comprising:
generating a plurality of processed images, by processing each of a plurality of time-series captured images;
calculating difference data representing a difference between the captured image and the processed image generated from the captured image, for each of the plurality of captured images; and
determining whether the captured image represents an abnormal state, based on a plurality of pieces of the calculated difference data,
wherein the processing executed on the captured image includes mask processing for masking one or more partial regions included in the captured image and restoration processing for restoring the masked partial region by using data other than the partial region.

14. The medium according to claim 13,
wherein the calculation of the difference data includes:
detecting, from the captured image, an image region representing a predetermined type of object that is not abnormal to be present in the captured image; and
calculating the difference data by calculating a difference between the captured image and the processed image generated from the captured image, for an image region excluding the detected image region.

15. The medium according to claim 13, wherein the calculation of the difference data includes detecting an image region representing a predetermined type of an object from the captured image, and the detected image region is excluded from a mask target.

16. The medium according to claim 13,
wherein the program further comprises a restoration model that has been trained to output, in response to an input of an image including a masked image region, an image in which the masked image region is restored,
wherein the calculation of the difference data includes executing the restoration processing by inputting the captured image in which the partial region is masked by the mask processing, into the restoration model, and
wherein, in a training of the restoration model, the image region representing the predetermined type of the object that is not abnormal to be present in the captured image is not included in a target of loss calculation.

17. The medium according to claim 13,
wherein the determination of whether the captured image represents an abnormal state includes:
calculating, for each of reference time points, a situation change degree representing a ratio of a statistical value of the difference data calculated for each of the plurality of captured images generated in a period after the reference time point, with respect to a statistical value of the difference data calculated for each of the plurality of captured images generated in a period before the reference time point; and
determining, in a case where the situation change degree calculated for the reference time point is equal to or more than a threshold, that the captured image generated at the reference time point represents an abnormal state.

18. The medium according to claim 17,
wherein the program further causes the computer to execute outputting a screen including the captured image,
wherein the output of the screen includes attenuating the situation change degree over time after it is determined that the situation change degree calculated for the reference time point is equal to or more than the threshold, and including, in the screen, a display indicating that the captured image represents the abnormal state, while the attenuated situation change degree is equal to or more than the situation change degree calculated for the newly acquired captured image.
